(19) United States
(12) Patent Application Publication
(10) Pub. No.: US 2024/0020533 A1
(43) Pub. Date: Jan. 18, 2024

(54) MODULARIZED PARAMETRIC VISUAL PROGRAM INDUCTION ALGORITHM, DEVICE, MEDIUM AND PRODUCT

(71) Applicant: Tsinghua University, Beijing (CN)

(72) Inventors: Wenwu ZHU, Beijing (CN); Xin WANG, Beijing (CN); Xuguang DUAN, Beijing (CN)

(73) Assignee: Tsinghua University, Beijing (CN)

(21) Appl. No.: 18/197,746

(22) Filed: May 16, 2023

(30) Foreign Application Priority Data
Jul. 18, 2022 (CN) 202210841172.6

(51) Int. Cl. G06N 3/08

(52) U.S. Cl. CPC G06N 3/08

(57) ABSTRACT

A modularized parametric visual program induction algorithm, a device, a medium and a product are provided. An optimized modularized parametric model is obtained by constructing a modularized parametric model and training with the cooperation of a hierarchical Monto-Carlo Tree-Search algorithm, data to be processed is input into the optimized modularized parametric model and processed in conjunction with the hierarchical Monto-Carlo Tree-Search algorithm, and a result program expression is output. The modularized parametric visual program induction algorithm is applicable to complex visual scenes; and model training data of the modularized parametric model is augmented in a training stage in conjunction with the hierarchical Monto-Carlo Tree-Search algorithm.

### CROSS REFERENCE TO THE RELATED APPLICATIONS

This application is based upon and claims priority to Chinese Patent Application No. 202210841172.6, filed on Jul. 18, 2022, the entire contents of which are incorporated herein by reference.

### TECHNICAL FIELD

Embodiments of the present disclosure relate to the technical field of visual program generation and, more particularly, to a modularized parametric visual program induction algorithm, a device, a storage medium and a product.

### BACKGROUND

The use of a programming language to describe visual contents has multiple advantages, which, on one hand, simulates a process of describing the world by humans, and uses a machine language to describe the visual contents viewed programmatically; and on the other hand, a generated program content may be used for automatically generating a required model by an automatic design tool (such as CAD and the like).

However, current technologies for generating visual content programs are based on non-parametric program generation, which cannot be applied to complex visual scenes. Specifically, on one hand, the complex visual scenes require more complex visual modeling models; on the other hand, the complex visual scenes require more complex program descriptions, which may cause program search space explosion. How to solve search space explosion, vision program induction and parameterized program generation at the same time is a problem to be solved urgently at present.

### SUMMARY

Embodiments of the present disclosure provide a modularized parametric visual program induction algorithm, a device, a medium and a product, aiming at solving the problems of search space explosion, visual program induction and parameterized program generation at a same time.

A first aspect of the embodiments of the present disclosure provides a modularized parametric visual program induction algorithm, wherein the method includes:
constructing a modularized parametric model, wherein the modularized parametric model includes a plurality of parametric submodels, different parametric submodels has different types of parameters, and the parameters are used for describing a plurality of attributes of data;
generating an augmented training data set based on a hierarchical Monto-Carlo Tree-Search algorithm and a basic training data set; and
training and optimizing the modularized parametric model based on the training data set to obtain an optimized modularized parametric model, wherein the optimized modularized parametric model includes optimized parametric submodels.

Optionally, the modularized parametric visual program induction algorithm, further including:
inputting data to be processed into the optimized modularized parametric model; and
processing the data to be processed by the optimized modularized parametric model in conjunction with the hierarchical Monto-Carlo Tree-Search algorithm, and outputting a result program expression.

Optionally, constructing the modularized parametric model includes:
constructing the parametric submodels based on different types of meta-functions of a target domain, wherein the parametric submodels are defined as sub-neural networks corresponding to the different types of parameters; and
combining the modularized parametric model with the parametric submodels corresponding to each of the different types of parameters, wherein the modularized parametric model is a set of the parametric submodels for the target domain.

Optionally, processing the data to be processed by the optimized modularized parametric model in conjunction with the hierarchical Monto-Carlo Tree-Search algorithm, and outputting the result program expression includes:
performing program expression on the data to be processed based on the different types of optimized parametric submodels in the optimized modularized parametric model;
searching, by the optimized modularized parametric model, a program expression in conformity with the data to be processed in the program expression based on the hierarchical Monto-Carlo Tree-Search algorithm as a target program expression; and
integrating, by the optimized modularized parametric model, the target program expression into the result program expression and outputting.

Optionally, the sub-neural network is:

m_{θ}^{ƒ}:[ [symbol] _{I}, [symbol] _{O}]→Θ
wherein, f is the meta-function, θ is the parameter, m_{θ}^{ƒ} is the sub-neural network, [ [symbol] _{I}, [symbol] _{O}] is a combination of a current input status-target output status, Θ refers to parameter prediction of the sub-neural network under [ [symbol] _{I}, [symbol] _{O}], and the corresponding meta-function at the moment is ƒ(·|Θ); and
the set of the parametric submodels is {m_{θ}^{ƒi}|ƒᵢ∈ [symbol] }, wherein [symbol] refers to a set of the meta-functions in the target domain, and ƒᵢ refers to an i-th meta-function in the set of the meta-functions.

Optionally, after constructing the modularized parametric model, generating the augmented training data set based on the hierarchical Monto-Carlo Tree-Search algorithm and the basic training data set includes:
providing, by the parametric submodels, search guidance for the hierarchical Monto-Carlo Tree-Search algorithm based on the corresponding different types of parameters;
augmenting, by the hierarchical Monto-Carlo Tree-Search algorithm, the basic training data set based on the search guidance to obtain the augmented training data set; and
augmenting, by the hierarchical Monto-Carlo Tree-Search algorithm, a combination mode of the parametric submodels to obtain an augmented parametric submodel combination.

Optionally, augmenting, by the hierarchical Monto-Carlo Tree-Search algorithm, the basic training data set based on the search guidance to obtain the augmented training data set is:

Pr[ [symbol] | [symbol] _{I}, [symbol] _{O}]=ΠP(ƒᵢ| [symbol] ᵢ, [symbol] _{O})·m_{θ}^{ƒi}(Θᵢ| [symbol] ᵢ, [symbol] _{O})

P(ƒᵢ| [symbol] ᵢ, [symbol] _{O})=Pr[∃Θᵢ:d(ƒᵢ( [symbol] ᵢ|Θᵢ), [symbol] ₒ)<d( [symbol] ᵢ, [symbol] ₒ)]

m_{θ}^{ƒi}(Θ| [symbol] ᵢ, [symbol] _{O})=argmin_{Θ}d(ƒᵢ( [symbol] ᵢ|Θ), [symbol] ₒ)

wherein, Pr[ [symbol] | [symbol] _{I}, [symbol] _{O}] is a probability of a program [symbol] when input-output is [ [symbol] _{I}, [symbol] _{O}]; P(ƒᵢ| [symbol] ᵢ, [symbol] _{O}) is a corresponding function probability when input-output is [ [symbol] ᵢ, [symbol] _{O}]; m_{θ}^{ƒi}(Θ| [symbol] ᵢ, [symbol] _{O}) is a corresponding parameter probability when input-output is [ [symbol] ᵢ, [symbol] _{O}]; d(·) is a corresponding distance measurement function in the target domain, which is used for screening the meta-function ƒᵢ capable of reducing a target distance when constructing P[ƒᵢ| [symbol] _{I}, [symbol] _{O}]; and argmin is used for selecting Θ capable of being minimized to the target distance when constructing the sub-neural network.

Optionally, after generating the augmented training data set, training and optimizing the modularized parametric model based on the augmented training data set to obtain the optimized modularized parametric model includes:
searching, by the hierarchical Monto-Carlo Tree-Search algorithm, appropriate augmented parametric submodel combinations in turn based on the search guidance;
inputting the augmented training data set into the appropriate augmented parametric submodel combinations for modeling, and calculating a loss function value;
optimizing the parameters corresponding to the parametric submodels in the appropriate augmented parametric submodel combinations based on the loss function value to obtain the optimized parametric submodels; and
combining the optimized parametric submodels into the optimized modularized parametric model.

A second aspect of the embodiments of the present disclosure provides an electronic device including a memory, a processor, and a computer program stored in the memory, wherein the processor, when executing the computer program, implements the steps of the modularized parametric visual program induction algorithm according to the embodiments of the present disclosure.

A third aspect of the embodiments of the present disclosure provides a computer-readable storage medium storing a computer program/instruction, which, when executed by a processor, implements the steps of the modularized parametric visual program induction algorithm according to the embodiments of the present disclosure.

A fourth aspect of the embodiments of the present disclosure provides a computer program product storing a computer program/instruction, which, when executed by a processor, implements the steps of the modularized parametric visual program induction algorithm according to the embodiments of the present disclosure.

### Advantages

According to the modularized parametric visual program induction algorithm, the device, the medium and the product provided by the present disclosure, the optimized modularized parametric model is obtained by constructing the modularized parametric model and training with the cooperation of the hierarchical Monto-Carlo Tree-Search algorithm, the data to be processed is input into the optimized modularized parametric model and processed in conjunction with the hierarchical Monto-Carlo Tree-Search algorithm, and the result program expression is output. The present disclosure has the following advantages.
(1) By constructing and training the modularized parametric model, the different types of parameters and parametric functions may be used in complex visual scenes, and the efficient expression of the different types of parameters can deal with various models in various scenes to generate appropriate program expressions, which has strong generalization ability.
(2) The training data of the modularized parametric model is augmented in a training stage in conjunction with the hierarchical Monto-Carlo Tree-Search algorithm to improve a training efficiency of the model. As an efficient search algorithm in a testing stage, a problem of program search space explosion caused by complex program expression is solved.

### BRIEF DESCRIPTION OF THE DRAWINGS

In order to more clearly illustrate the technical solutions of the embodiments of the present disclosure, the drawings that are required to describe the embodiments of the present disclosure will be briefly introduced below. Apparently, the drawings that are described below are only some embodiments of the present disclosure, and those of ordinary skills in the art can obtain other drawings according to these drawings without paying creative work.

FIG. 1 is a flow chart of a modularized parametric model training method provided according to an embodiment of the present disclosure; and

FIG. 2 is a flow chart for the use of a modularized parametric visual program induction algorithm provided according to an embodiment of the present disclosure.

### DETAILED DESCRIPTION OF THE EMBODIMENTS

Hereinafter, the technical solutions in the embodiments of the present disclosure are illustrated clearly and completely with the accompanying drawings in the embodiments of the present disclosure. Apparently, the described embodiments are merely some but not all of the embodiments of the present disclosure. Based on the embodiments in the present disclosure, all other embodiments obtained by those of ordinary skills in the art without going through any creative work shall fall within the scope of protection of the present disclosure.

In the related art, technologies for generating visual content programs are based on non-parametric program generation, which cannot be applied to complex visual scenes. Specifically, on one hand, the complex visual scenes require more complex visual modeling models; on the other hand, the complex visual scenes require more complex program descriptions, which may cause program search space explosion. How to solve search space explosion, vision program induction and parameterized program generation at the same time is a problem to be solved urgently at present.

In light of this, the embodiments of the present disclosure provide a modularized parametric visual program induction algorithm, which obtains an optimized modularized parametric model by constructing a modularized parametric model and training with the cooperation of a hierarchical Monto-Carlo Tree-Search algorithm, data to be processed is input into the optimized modularized parametric model and the data to be processed is processed in conjunction with the hierarchical Monto-Carlo Tree-Search algorithm, and an appropriate result program expression is output.

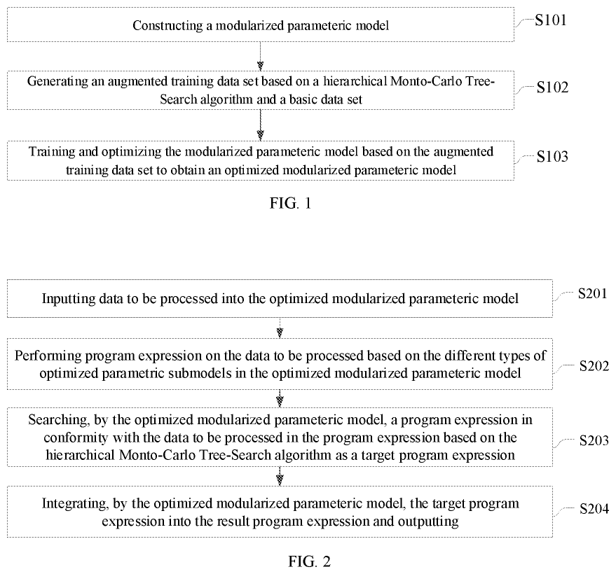

Firstly, the modularized parametric model in the modularized parametric visual program induction algorithm is constructed and trained. FIG. 1 shows a flow chart of a modularized parametric model training method. As shown in FIG. 1, the modularized parametric model training method provided by the embodiments of the present disclosure specifically includes the following steps:

S101: constructing a modularized parametric model.

During specific implementation, a plurality of different types of parameters are determined first, wherein the parameters are used for describing a plurality of attributes of data. Different types of parameters relate to as many fields and directions as possible, and are used to characterize the possible attributes of various types of data to be processed, for example, a parameter used to describe a bottom radius of a cup, a parameter used to describe a height of a bottle, a parameter used to describe an area of a box, or the like.

Then, for each of the different types of parameters and different meta-functions of a target domain (for example, different drawing instructions in a CAD domain), parametric submodels corresponding to each of the different types of parameters are constructed, and the parametric submodels are defined as sub-neural networks corresponding to the different types of parameters. Each parametric submodel has a specific type of sub-function, and each sub-function corresponds to one type of parameter, so that the different parametric submodels may correspond to one attribute of the data, such that each parametric submodel can operate independently.

The sub-neural network is specifically as follows:

m_{θ}^{ƒ}:[ [symbol] _{I}, [symbol] _{O}]→Θ
wherein, f is the meta-function, θ is the parameter, m_{θ}^{ƒ} is the sub-neural network, [ [symbol] _{I}, [symbol] _{O}] is a combination of a current input status-target output status, Θ refers to parameter prediction of the sub-neural network under [ [symbol] _{I}, [symbol] _{O}], and the corresponding meta-function at the moment is ƒ(·|Θ); and
the set of the parametric submodels is {m_{θ}^{ƒi}|ƒᵢ∈ [symbol] } specifically, wherein [symbol] refers to a set of the meta-functions in the target domain, and ƒᵢ refers to an i-th meta-function in the set of the meta-functions.

The parametric submodels corresponding to each of the different types of parameters are combined into the modularized parametric model. The modularized parametric model is a set of the parametric submodels for the target domain, and includes a plurality of parametric submodels, wherein different parametric submodels has different types of parameters.

S102: generating an augmented training data set based on a hierarchical Monto-Carlo Tree-Search algorithm and a basic data set.

During specific implementation, the parametric submodels provide search guidance for the hierarchical Monto-Carlo Tree-Search algorithm based on the corresponding different types of parameters. Specifically, the different types of parameters in the parametric submodels provide prior knowledge for the hierarchical Monto-Carlo Tree-Search algorithm as the search guidance, reducing a search space of the hierarchical Monto-Carlo Tree-Search algorithm.

The hierarchical Monto-Carlo Tree-Search algorithm excludes data unrelated to the target data in the basic training data set based on the search guidance, and directionally augments the search space of the basic training data set to obtain the augmented training data set. Meanwhile, the hierarchical Monto-Carlo Tree-Search algorithm augments a combination mode of the parametric submodels to obtain an augmented parametric submodel combination.

The Monto-Carlo Tree-Search algorithm (MCTS) is a search method based on tree structure, which is still effective in a huge search space, and is a method that uses random numbers (or more common pseudo-random numbers) to solve many calculation problems. A problem to be solved is related to a certain probability model, and an approximate solution of the problem can be obtained by statistical simulation or sampling with an electronic computer. The Monto-Carlo search tree is focused on branches that are worth searching. If a certain method is good, the Monte Carlo tree may expand the method deeply; otherwise, the method may not be expanded. According to the present disclosure, the hierarchical Monto-Carlo Tree-Search algorithm which may be applied to the modularized parametric model is obtained by limiting a scene of the original Monto-Carlo tree. The hierarchical Monto-Carlo Tree-Search algorithm excludes the data unrelated to the target data in the basic training data set based on the search guidance, thus reducing dependence of the parametric submodels on the training data.

Specifically, the embodiments of the present disclosure perform directional augmentation of the search space on the basic training data set based on the following method to obtain the augmented training data set:

Pr[ [symbol] | [symbol] _{I}, [symbol] _{O}]=ΠP(ƒᵢ| [symbol] ᵢ, [symbol] _{O})·m_{θ}^{ƒi}(Θᵢ| [symbol] ᵢ, [symbol] _{O})

P(ƒᵢ| [symbol] ᵢ, [symbol] _{O})=Pr[∃Θᵢ:d(ƒᵢ( [symbol] ᵢ|Θᵢ), [symbol] ₒ)<d( [symbol] ᵢ, [symbol] ₒ)]

m_{θ}^{ƒi}(Θ| [symbol] ᵢ, [symbol] _{O})=argmin_{Θ}d(ƒᵢ( [symbol] ᵢ|Θ), [symbol] ₒ)

wherein, Pr[ [symbol] | [symbol] _{I}, [symbol] _{O}] is a probability of a program [symbol] when input-output is [ [symbol] _{I}, [symbol] _{O}]; P(ƒᵢ| [symbol] ᵢ, [symbol] _{O}) is a corresponding function probability when input-output is [ [symbol] ᵢ, [symbol] _{O}]; m_{θ}^{ƒi}(Θ| [symbol] ᵢ, [symbol] _{O}) is a corresponding parameter probability when input-output is [ [symbol] ᵢ, [symbol] _{O}]; d(·) is a corresponding distance measurement function in the target domain, which is used for screening the meta-function ƒᵢ capable of reducing a target distance when constructing P(ƒᵢ| [symbol] ᵢ, [symbol] _{O}); and argmin is used for selecting Θ capable of being minimized to the target distance when constructing the sub-neural network.

S103: training and optimizing the modularized parametric model based on the training data set to obtain an optimized modularized parametric model.

During specific implementation, the hierarchical Monto-Carlo Tree-Search algorithm searches appropriate augmented parametric submodel combinations (including appropriate sub-functions and appropriate function parameters) in turn based on the search guidance.

The augmented training data set is input into the appropriate augmented parametric submodel combinations for modeling, and a loss function value is calculated; and then, the parameters corresponding to the parametric submodels in the appropriate augmented parametric submodel combinations are optimized based on the loss function value to obtain the optimized parametric submodels.

The optimized parametric submodels are combined into the optimized modularized parametric model.

The hierarchical construction of the Monto-Carlo search tree can traverse the function space efficiently, and based on the search guidance, the data unrelated to the target data in the basic training data set can be excluded, so that the hierarchical construction of the Monto-Carlo search tree can reduce the search space in the search process, thus solving a problem of program diversification modeling and effectively solving additional challenges brought by the diversification of program expression to model learning in the training process.

After constructing and optimizing the modularized parametric model to get the optimized modularized parametric model, a testing stage is entered. FIG. 2 shows a flow chart for the use of the modularized parametric visual program induction algorithm. As shown in FIG. 2, the specific steps are as follows:

S201: inputting data to be processed into the optimized modularized parametric model.

During specific implementation, the data to be processed is input into the optimized modularized parametric model, wherein the data to be processed may be image data, 3D model data and other types of visual data, and is not specifically limited in the present disclosure.

S202: performing program expression on the data to be processed based on the different types of optimized parametric submodels in the optimized modularized parametric model.

During specific implementation, based on attributes corresponding to the different types of parameters contained in the optimized parametric submodels, it is tried to perform program expression on these attributes of the input data to be processed. For example, if a parameter a is used to describe a bottom radius of a cup, a parametric submodel containing the parameter a tries to output a program expression about the bottom radius of the cup for the data to be processed.

S203: searching, by the optimized modularized parametric model, a program expression in conformity with the data to be processed in the program expression based on the hierarchical Monto-Carlo Tree-Search algorithm as a target program expression.

Because the attributes represented by the various parametric submodels in the optimized modularized parametric model may or may not be related to the data to be processed, in order to effectively reduce a search space and a problem of program diversity modeling, the hierarchical Monto-Carlo Tree-Search algorithm may efficiently traverse the program expressions obtained by all parametric submodels and search out the program expression related to the data to be processed as the target program expression of the data to be processed. While the program expressions unrelated to the data to be processed are excluded from a function space.

S204: integrating, by the optimized modularized parametric model, the target program expression into the result program expression and outputting.

During specific implementation, all of the target program expressions which are efficiently searched based on the hierarchical Monto-Carlo Tree-Search algorithm and conform to the data to be processed are integrated into the result program expression, and output as an algorithm.

The following is a detailed description of the above-mentioned modularized parametric visual program induction algorithm with reference to the specific examples.

The optimized modularized parametric model has the parametric submodels corresponding to the different types of parameters, which involve as many fields and directions as possible and are used to represent possible attributes of various types of data to be processed. For example, there are many different types of submoduls to handle different types of objects, such as a parametric submodel CUP including the parameters cup_height, cup_volume, cup_color, to describe the height, volume, and color of a cup, a parametric submodel BOX including the parameter box_width, box_height, box_length to describe the width, height, length of a box.

A landscape architecture picture is input into the optimized modularized parametric model, and based on the attributes corresponding to the different types of parameters contained in the optimized parametric submodels, an attempt is made to perform program expression on these attributes of the input landscape picture. For example, the parametric submodel A tries to perform program expression on a bottom radius of a cup in the landscape picture, the parametric submodel B tries to perform program expression on a height of a bottle in the landscape picture, the parametric submodel C tries to perform program expression on an area of a box area in the landscape picture, the parametric submodel D tries to perform program expression on an exposure value in the landscape picture, the parametric submodel E tries to perform program expression on a color temperature of a plant in the landscape picture, and so on for other parametric submodels.

The hierarchical Monto-Carlo Tree-Search algorithm may combine the program expressions obtained by all the parametric submodels and traverse the program expressions efficiently, and search out the program expressions related to the information in the landscape architecture picture, such as the program expressions output by the parametric submodels corresponding to the color temperature of the plant, the colority of the flower, the exposure value, or the like, as the target program expressions. However, the program expressions which are unrelated to the information in the landscape architecture picture, such as the program expressions output by the parametric submodels corresponding to the bottom radius of the cup, the height of the bottle and the area of the box, or the like, are excluded from the function space as invalid program expressions.

The optimized modularized parametric model integrates the target program expressions into the result program expression, which is used as the output of the algorithm, and a group of result program expressions about the landscape architecture picture output by the modularized parametric visual program induction algorithm are obtained. The result program expression may be directly used in drawing software (such as CAD, or the like) as a programming language, and a needed model or picture can be automatically generated by inputting the result program expression into the drawing software.

According to the modularized parametric visual program induction algorithm, the device, the medium and the product provided by the embodiments of the present disclosure, the optimized modularized parametric model is obtained by constructing the modularized parametric model and training with the cooperation of the hierarchical Monto-Carlo Tree-Search algorithm, the data to be processed is input into the optimized modularized parametric model and processed in conjunction with the hierarchical Monto-Carlo Tree-Search algorithm, and the result program expression is output. The present disclosure has the following advantages.
(1) By constructing and training the modularized parametric model, the different types of parameters and parametric functions may be used in complex visual scenes, and the efficient expression of the different types of parameters can deal with various models in various scenes to generate appropriate program expressions, which has strong generalization ability.
(2) The training data of the modularized parametric model is augmented in a training stage in conjunction with the hierarchical Monto-Carlo Tree-Search algorithm to improve a training efficiency of the model. As an efficient search algorithm in a testing stage, a problem of program search space explosion caused by complex program expression is solved.

Based on the same inventive concept, an embodiment of the present disclosure provides an electronic device including a memory, a processor, and a computer program stored in the memory, wherein the processor, when executing the computer program, implements the steps of the modularized parametric visual program induction algorithm according to the embodiments of the present disclosure.

Another embodiment of the present disclosure also provides a computer-readable storage medium storing a computer program/instruction, which, when executed by a processor, implements the steps of the modularized parametric visual program induction algorithm according to the embodiments of the present disclosure.

Another embodiment of the present disclosure also provides a computer program product, including a computer program/instruction, which, when executed by a processor, implements the steps of the modularized parametric visual program induction algorithm according to the embodiments of the present disclosure.

In the above-mentioned embodiments, it may be realized in whole or in part by software, hardware, firmware or any combination thereof. When it is implemented using software, it may be implemented in whole or in part in the form of a computer program product. The computer program product includes one or more computer instructions. When the computer program instructions are loaded and executed on a computer, the processes or functions according to the embodiments of the present disclosure are generated in whole or in part. The computer may be a general computer, a special purpose computer, a computer network, or other programmable apparatus. The computer instruction may be stored in a computer readable storage medium or transmitted from one computer readable storage medium to another computer readable storage medium, for example, the computer instruction may be transmitted from one website site, computer, server or data center to another website site, computer, server or data center by wired (e.g., coaxial cable, optical fiber, Digital Subscriber Line (DSL)) or wireless (e.g., infrared, wireless, microwave, etc.) manners. The computer-readable storage medium may be any available medium that a computer can access or a data storage device such as a server, a data center, or the like that includes one or more available media integration. The available medium may be a magnetic medium (e.g., floppy disk, hard disk, magnetic tape), an optical medium (e.g., DVD), or semiconductor medium (e.g., Solid State Disk (SSD)) or the like.

It should be noted that relational terms herein such as first and second, etc., are used merely to distinguish one entity or operation from another entity or operation, and do not necessarily require or imply there is any such relationship or order between these entities or operations. Furthermore, the terms “including”, “comprising” or any variations thereof are intended to embrace a non-exclusive inclusion, such that a process, method, article, or device including a plurality of elements includes not only those elements but also includes other elements not expressly listed, or also incudes elements inherent to such a process, method, article, or device. In the absence of further limitation, an element defined by the phrase “including a . . . ” does not exclude the presence of additional identical element in the process, method, article, or device.

All the embodiments in this specification are described in relevant ways, the same and similar parts between the embodiments may be referred to each other, and each embodiment focuses on the differences from other embodiments. Particularly, as for the system embodiment, since it is basically similar to the method embodiment, the description of the device embodiment is relatively simple. For relevant points, please refer to the partial description of the method embodiment.

The technical solutions provided by the present disclosure are described in detail above. Specific examples are applied to explain the principle and implementation of the present disclosure herein. The above embodiments are only used to help understand the present disclosure, and the contents of this specification should not be construed as limitations on the present disclosure. Meanwhile, for those of ordinary skills in the art, there may be different forms of changes in the specific embodiments and application scope according to the present disclosure, and it is not necessary and impossible to exhaust all the embodiments here, while the obvious changes or variations derived therefrom are still within the protection scope of the present disclosure.

What is claimed is:

1. A modularized parametric visual program induction method, comprising:
constructing a modularized parametric model, wherein the modularized parametric model comprises a plurality of parametric submodels, different parametric submodels have different types of parameters, and the different types of parameters are configured for describing a plurality of attributes of data;
generating an augmented training data set based on a hierarchical Monto-Carlo Tree-Search algorithm and a basic training data set; and
training and optimizing the modularized parametric model based on the augmented training data set to obtain an optimized modularized parametric model, wherein the optimized modularized parametric model comprises optimized parametric submodels.

2. The modularized parametric visual program induction method according to claim 1, further comprising:
inputting data to be processed into the optimized modularized parametric model; and
processing the data to be processed by the optimized modularized parametric model in conjunction with the hierarchical Monto-Carlo Tree-Search algorithm, and outputting a result program expression.

3. The modularized parametric visual program induction method according to claim 1, wherein the operation of constructing the modularized parametric model comprises:
constructing the plurality of parametric submodels based on different types of meta-functions of a target domain, wherein the plurality of parametric submodels are defined as sub-neural networks corresponding to the different types of parameters; and
combining the modularized parametric model with the plurality of parametric submodels corresponding to each of the different types of parameters, wherein the modularized parametric model is a set of the plurality of parametric submodels for the target domain.

4. The modularized parametric visual program induction method according to claim 2, wherein the operation of processing the data to be processed by the optimized modularized parametric model in conjunction with the hierarchical Monto-Carlo Tree-Search algorithm, and outputting the result program expression comprises:
performing a program expression on the data to be processed based on the different types of optimized parametric submodels in the optimized modularized parametric model;
searching, by the optimized modularized parametric model, a program expression in conformity with the data to be processed in the program expression based on the hierarchical Monto-Carlo Tree-Search algorithm as a target program expression; and
integrating, by the optimized modularized parametric model, the target program expression into the result program expression and outputting.

5. The modularized parametric visual program induction method according to claim 3, wherein the sub-neural network is:
m_{θ}^{ƒ}:[ [symbol] _{I}, [symbol] _{O}]→Θ
wherein, f is the meta-function, θ is the different types of parameters, m_{θ}^{ƒ} is the sub-neural network, [ [symbol] _{I}, [symbol] _{O}] is a combination of a current input status-target output status, Θ refers to a parameter prediction of the sub-neural network under [ [symbol] _{I}, [symbol] _{O}], and the meta-function at the moment is ƒ(·|Θ); and
the set of the plurality of parametric submodels is {m_{θ}^{ƒi}|ƒᵢ∈ [symbol] }, wherein [symbol] refers to a set of the meta-functions in the target domain, and ƒᵢ refers to an i-th meta-function in the set of the meta-functions.

6. The modularized parametric visual program induction method according to claim 3, wherein after constructing the modularized parametric model, the operation of generating the augmented training data set based on the hierarchical Monto-Carlo Tree-Search algorithm and the basic training data set comprises:
providing, by the plurality of parametric submodels, a search guidance for the hierarchical Monto-Carlo Tree-Search algorithm based on the different types of parameters;
augmenting, by the hierarchical Monto-Carlo Tree-Search algorithm, the basic training data set based on the search guidance to obtain the augmented training data set; and
augmenting, by the hierarchical Monto-Carlo Tree-Search algorithm, a combination mode of the plurality of parametric submodels to obtain an augmented parametric submodel combination.

7. The modularized parametric visual program induction method according to claim 6, wherein the operation of augmenting, by the hierarchical Monto-Carlo Tree-Search algorithm, the basic training data set based on the search guidance to obtain the augmented training data set is:
Pr[ [symbol] | [symbol] _{I}, [symbol] _{O}]=ΠP(ƒᵢ| [symbol] ᵢ, [symbol] _{O})·m_{θ}^{ƒi}(Θᵢ| [symbol] ᵢ, [symbol] _{O})
P(ƒᵢ| [symbol] ᵢ, [symbol] _{O})=Pr[∃Θᵢ:d(ƒᵢ( [symbol] ᵢ|Θᵢ), [symbol] ₒ)<d( [symbol] ᵢ, [symbol] ₒ)]
m_{θ}^{ƒi}(Θ| [symbol] ᵢ, [symbol] _{O})=argmin_{Θ}d(ƒᵢ( [symbol] ᵢ|Θ), [symbol] ₒ)
wherein, Pr[ [symbol] | [symbol] _{I}, [symbol] _{O}] is a probability of a program [symbol] when input-output is [ [symbol] _{I}, [symbol] _{O}]; P(ƒᵢ| [symbol] ᵢ, [symbol] _{O}) is a function probability when the input-output is [ [symbol] ᵢ, [symbol] _{O}] m_{θ}^{ƒi}(Θ| [symbol] ᵢ, [symbol] _{O}) is a parameter probability when the input-output is [ [symbol] ᵢ, [symbol] _{O}]; d(·) is a distance measurement function in the target domain, wherein d(·) is configured for screening the meta-function ƒᵢ allowed for reducing a target distance when constructing P(ƒᵢ| [symbol] ᵢ, [symbol] _{O}); and argmin is configured for selecting Θ allowed for being minimized to the target distance when constructing the sub-neural network.

8. The modularized parametric visual program induction method according to claim 6, wherein after generating the augmented training data set, the operation of training and optimizing the modularized parametric model based on the augmented training data set to obtain the optimized modularized parametric model comprises:
searching, by the hierarchical Monto-Carlo Tree-Search algorithm, appropriate augmented parametric submodel combinations in turn based on the search guidance;
inputting the augmented training data set into the appropriate augmented parametric submodel combinations for modeling, and calculating a loss function value;
optimizing the different types of parameters corresponding to the plurality of parametric submodels in the appropriate augmented parametric submodel combinations based on the loss function value to obtain the optimized parametric submodels; and
combining the optimized parametric submodels into the optimized modularized parametric model.

9. An electronic device, comprising a memory, a processor, and a computer program stored in the memory, wherein the processor, when executing the computer program, implements operations of a modularized parametric visual program induction method, wherein the operations comprise:
constructing a modularized parametric model, wherein the modularized parametric model comprises a plurality of parametric submodels, different parametric submodels have different types of parameters, and the different types of parameters are configured for describing a plurality of attributes of data;
generating an augmented training data set based on a hierarchical Monto-Carlo Tree-Search algorithm and a basic training data set; and
training and optimizing the modularized parametric model based on the augmented training data set to obtain an optimized modularized parametric model, wherein the optimized modularized parametric model comprises optimized parametric submodels.

10. A computer-readable storage medium storing a computer program/instruction, wherein the computer program/instruction, when executed by a processor, implements operations of a modularized parametric visual program induction method, wherein the operations comprise:
constructing a modularized parametric model, wherein the modularized parametric model comprises a plurality of parametric submodels, different parametric submodels have different types of parameters, and the different types of parameters are configured for describing a plurality of attributes of data;
generating an augmented training data set based on a hierarchical Monto-Carlo Tree-Search algorithm and a basic training data set; and
training and optimizing the modularized parametric model based on the augmented training data set to obtain an optimized modularized parametric model, wherein the optimized modularized parametric model comprises optimized parametric submodels.

11. The electronic device according to claim 9, wherein the modularized parametric visual program induction method further comprises:
inputting data to be processed into the optimized modularized parametric model; and
processing the data to be processed by the optimized modularized parametric model in conjunction with the hierarchical Monto-Carlo Tree-Search algorithm, and outputting a result program expression.

12. The electronic device according to claim 9, wherein the operation of constructing the modularized parametric model comprises:
constructing the plurality of parametric submodels based on different types of meta-functions of a target domain, wherein the plurality of parametric submodels are defined as sub-neural networks corresponding to the different types of parameters; and
combining the modularized parametric model with the plurality of parametric submodels corresponding to each of the different types of parameters, wherein the modularized parametric model is a set of the plurality of parametric submodels for the target domain.

13. The electronic device according to claim 11, wherein the operation of processing the data to be processed by the optimized modularized parametric model in conjunction with the hierarchical Monto-Carlo Tree-Search algorithm, and outputting the result program expression comprises:
performing a program expression on the data to be processed based on the different types of optimized parametric submodels in the optimized modularized parametric model;
searching, by the optimized modularized parametric model, a program expression in conformity with the data to be processed in the program expression based on the hierarchical Monto-Carlo Tree-Search algorithm as a target program expression; and
integrating, by the optimized modularized parametric model, the target program expression into the result program expression and outputting.

14. The electronic device according to claim 12, wherein the sub-neural network is:
m_{θ}^{ƒ}:[ [symbol] _{I}, [symbol] _{O}]→Θ
wherein, f is the meta-function, θ is the different types of parameters, m_{θ}^{ƒ} is the sub-neural network, [ [symbol] _{I}, [symbol] _{O}] is a combination of a current input status-target output status, Θ refers to a parameter prediction of the sub-neural network under [ [symbol] _{I}, [symbol] _{O}], and the meta-function at the moment is ƒ(·|Θ); and
the set of the plurality of parametric submodels is {m_{θ}^{ƒi}|ƒᵢ∈ [symbol] }, wherein [symbol] refers to a set of the meta-functions in the target domain, and ƒᵢ refers to an i-th meta-function in the set of the meta-functions.

15. The electronic device according to claim 12, wherein after constructing the modularized parametric model, the operation of generating the augmented training data set based on the hierarchical Monto-Carlo Tree-Search algorithm and the basic training data set comprises:
providing, by the plurality of parametric submodels, a search guidance for the hierarchical Monto-Carlo Tree-Search algorithm based on the different types of parameters;
augmenting, by the hierarchical Monto-Carlo Tree-Search algorithm, the basic training data set based on the search guidance to obtain the augmented training data set; and
augmenting, by the hierarchical Monto-Carlo Tree-Search algorithm, a combination mode of the plurality of parametric submodels to obtain an augmented parametric submodel combination.

16. The computer-readable storage medium according to claim 10, wherein the modularized parametric visual program induction method further comprises:
inputting data to be processed into the optimized modularized parametric model; and
processing the data to be processed by the optimized modularized parametric model in conjunction with the hierarchical Monto-Carlo Tree-Search algorithm, and outputting a result program expression.

17. The computer-readable storage medium according to claim 10, wherein the operation of constructing the modularized parametric model comprises:
constructing the plurality of parametric submodels based on different types of meta-functions of a target domain, wherein the plurality of parametric submodels are defined as sub-neural networks corresponding to the different types of parameters; and
combining the modularized parametric model with the plurality of parametric submodels corresponding to each of the different types of parameters, wherein the modularized parametric model is a set of the plurality of parametric submodels for the target domain.

18. The computer-readable storage medium according to claim 16, wherein the operation of processing the data to be processed by the optimized modularized parametric model in conjunction with the hierarchical Monto-Carlo Tree-Search algorithm, and outputting the result program expression comprises:
performing a program expression on the data to be processed based on the different types of optimized parametric submodels in the optimized modularized parametric model;
searching, by the optimized modularized parametric model, a program expression in conformity with the data to be processed in the program expression based on the hierarchical Monto-Carlo Tree-Search algorithm as a target program expression; and
integrating, by the optimized modularized parametric model, the target program expression into the result program expression and outputting.

19. The computer-readable storage medium according to claim 17, wherein the sub-neural network is:
m_{θ}^{ƒ}:[ [symbol] _{I}, [symbol] _{O}]→Θ
wherein, f is the meta-function, θ is the different types of parameters, m_{θ}^{ƒ} is the sub-neural network, [ [symbol] _{I}, [symbol] _{O}] is a combination of a current input status-target output status, Θ refers to a parameter prediction of the sub-neural network under [ [symbol] _{I}, [symbol] _{O}], and the meta-function at the moment is ƒ(·|Θ); and
the set of the plurality of parametric submodels is {m_{θ}^{ƒi}|ƒᵢ∈ [symbol] }, wherein [symbol] refers to a set of the meta-functions in the target domain, and ƒᵢ refers to an i-th meta-function in the set of the meta-functions.

20. The computer-readable storage medium according to claim 17, wherein after constructing the modularized parametric model, the operation of generating the augmented training data set based on the hierarchical Monto-Carlo Tree-Search algorithm and the basic training data set comprises:
providing, by the plurality of parametric submodels, a search guidance for the hierarchical Monto-Carlo Tree-Search algorithm based on the different types of parameters;
augmenting, by the hierarchical Monto-Carlo Tree-Search algorithm, the basic training data set based on the search guidance to obtain the augmented training data set; and
augmenting, by the hierarchical Monto-Carlo Tree-Search algorithm, a combination mode of the plurality of parametric submodels to obtain an augmented parametric submodel combination.
